(19) United States
(12) Patent Application Publication
(10) Pub. No.: US 2013/0119695 A1
(43) Pub. Date: May 16, 2013

(54) SEAT MOUNTING

(71) Applicant: GM GLOBAL TECHNOLOGY OPERATIONS LLC, Detroit, MI (US)

(72) Inventors: Stephan Rosenplaenter, Sulzheim (DE); Matthias Becker, Harxheim (DE); Stefan Gloger, Muehltal (DE)

(73) Assignee: GM GLOBAL TECHNOLOGY OPERATIONS LLC, Detroit, MI (US)

(21) Appl. No.: 13/670,945

(22) Filed: Nov. 7, 2012

(30) Foreign Application Priority Data
Nov. 10, 2011 (DE) 102011118179.6

(51) Int. Cl. B60N 2/015; B60N 2/10

(52) U.S. Cl. CPC B60N 2/015; B60N 2/10
USPC 296/37.2; 297/344.1; 297/217.1

(57) ABSTRACT

A seat mounting for mounting at least one motor vehicle seat on a motor vehicle body is provided. The seat mounting includes a supporting structure for accommodating the at least one seat. The supporting structure is mounted on the motor vehicle body in a pivoted fashion by means of at least one hinge and can be transferred between a normal position and a lifted loading position.

### CROSS-REFERENCE TO RELATED APPLICATION

This application claims priority to German Patent Application No. 10 2011 118 179.6, filed Nov. 10, 2011, which is incorporated herein by reference in its entirety.

### TECHNICAL FIELD

This application pertains to a seat mounting with integrated spare tire mounting and a functional integration for mounting at least one motor vehicle seat on a motor vehicle body and, in particular, a seat mounting for the third row of seats of a minivan, a multi-purpose vehicle (MPV), a minibus or utility van.

### BACKGROUND

In motor vehicles with three rows of seats that are arranged behind one another in the driving direction, only a limited transport volume for other objects to be carried along in the motor vehicle is frequently available in the vehicle interior. The third row of seats is typically arranged in the region of the rear wheels and therefore in the region of the rear cargo floor. The third row of seats or corresponding individual seats provided above the cargo floor prevent said cargo floor from being lifted such that it would be impractical to carry along a spare tire in a spare tire recess that is accessible from above and arranged underneath a cargo floor that can be lifted.

In vehicles of this type such as, for example, minivans, multi-purpose vehicles (MPV) or minibuses, it is therefore common practice to stow a spare tire outside the motor vehicle underneath a cargo floor. In this case, the spare tire carried along outside the vehicle can, if so required, be pulled out of a stowage position underneath the cargo floor, e.g., toward the rear.

Carrying along a spare tire outside a motor vehicle is considered disadvantageous compared with an arrangement in the motor vehicle interior. In the motor vehicle interior, the spare tire can be better protected from moisture, dirt and dust and therefore also better protected from corrosion and premature aging processes.

If a third row of seats is provided, it is also necessary to configure a safety system that suffices for the interior protection of occupants. Similar to the second row of seats or the front seats, seat belt systems for the vehicle occupants need to be provided on the third row of seats and connected to supporting structural components of the motor vehicle body in a sufficiently stable fashion. In this respect, a seat belt buckle that is arranged approximately in the center of the vehicle needs to be structurally connected to components of the motor vehicle body to a sufficient degree, i.e., in a load-transmitting fashion.

Accordingly, it is desirable to provide a seat mounting, particularly for a third row of seats of a motor vehicle, that is improved with respect to the stowage compartment layout, and that makes it possible, in particular, to accommodate a spare tire in the interior of the motor vehicle and at the same time advantageously affects the accommodation and arrangement of a safety system for the vehicle occupants. The seat mounting should furthermore contribute to reducing the motor vehicle weight and therefore to reducing the fuel consumption.

In addition, other objects, desirable features and characteristics will become apparent from the subsequent summary and detailed description, and the appended claims, taken in conjunction with the accompanying drawings and this background.

### SUMMARY

According to various exemplary embodiments, a seat mounting is provided for mounting at least one motor vehicle seat on a motor vehicle body. In this case, the seat mounting features a supporting structure for accommodating the at least one seat. The supporting structure furthermore can be mounted on the motor vehicle body in a pivoted fashion by means of at least one hinge. It therefore provides a pivoted mounting structure for at least one motor vehicle seat such that all seats mounted on the supporting structure, generally the seats of a third row of seats or the entire third row of seats, can be transferred from a normal position into a loading position, in which they are generally folded forward.

In the loading position, a cargo floor situated underneath the supporting structure can be at least sectionally lifted in order to gain access to a spare tire recess arranged underneath the cargo floor. Due to the pivoted support of the seat mounting and its supporting structure, the spare tire can be accommodated in the motor vehicle interior, generally underneath a rear cargo floor that is accessible from above. Since the seat mounting can be pivoted into a loading position, for example, toward the front referred to the driving direction of the motor vehicle, access to the cargo floor situated thereunder can be provided from above without having to remove the seats of the third row of seats from the vehicle.

The altogether pivoted arrangement of the seat mounting or its supporting structure that accommodates the seats respectively proves advantageous with respect to the interior accessibility of a spare tire recess that is arranged thereunder referred to the vertical vehicle direction (z).

According to another exemplary embodiment, the supporting structure features at least one mounting element that is spaced apart from the hinge and can be connected to a spare tire mounting of the motor vehicle provided underneath the supporting structure. Since the supporting structure of the seat mounting features a mounting element for being directly connected to a spare tire mounting arranged inside the motor vehicle underneath the supporting structure, the supporting structure can be connected to the motor vehicle body at several points that are spaced apart from one another. The connection between the supporting structure and the motor vehicle body can contribute to a mutual stabilization of the supporting structure and the motor vehicle body such that the supporting structure, as well as the supporting structural components of the motor vehicle body to be connected thereto, need to fulfill correspondingly lower mechanical load requirements and can be designed in a correspondingly weight-saving fashion.

The structural connection of the supporting structure of the seat mounting to a spare tire mounting provided on the motor vehicle body furthermore makes it possible to reduce the number of components that otherwise would typically be required for mounting the supporting structure on the motor vehicle.

According to another exemplary embodiment, the supporting structure of the seat mounting features at least one cross member that substantially extends in the lateral vehicle direction (y), as well as at least one limb that connects the cross member to the at least one hinge. In this case, the limb generally extends perpendicular to the cross member and therefore in the longitudinal vehicle direction (x). The cross member is furthermore provided on a region that faces away from the hinge of the supporting structure in order to also provide the supporting structure with sufficient stability and torsional rigidity in a region that faces away from the at least one hinge. The cross member furthermore makes it possible to separately mount the supporting structure of the seat mounting on the motor vehicle body, for example, on its supporting structural components, in a substantially detachable fashion.

According to another exemplary embodiment, the supporting structure is provided for accommodating at least two adjacently arranged motor vehicles seats. It furthermore features a central limb that extends between the seats and connects the cross member to a hinge of the supporting structure. The central limb is generally situated about centrally between the at least two seats, in one example, in the center between the outer edge regions of the supporting structure referred to the lateral vehicle direction (y). In this case, the central limb and the cross member form a T-like supporting structure in the x-y plane defined by the longitudinal vehicle direction (x) and the lateral vehicle direction (y).

According to another exemplary embodiment, at least one belt buckle for a seat belt, generally for a two-point or three-point seat belt, is provided on the central limb. This makes it possible, in one example, to divert tensile forces acting upon a seat belt buckle in case of a mechanical load into the motor vehicle body via the central limb of the supporting structure of the seat mounting.

According to an exemplary embodiment, it is proposed, in one example, that the mounting element of the supporting structure which is spaced apart from the hinge is also arranged on the central limb and accessible from the underside, i.e., from a side that faces away from the seat belt buckle. In this case, the seat belt buckle and the mounting element of the central limb likewise may be arranged such that they are spaced apart from the hinge. The mounting element, in one example, may be provided on the central limb in the immediate vicinity of the seat belt buckle, but also a greater distance therefrom. In this respect, the mounting element may be provided on an end section of the central limb that faces away from the hinge or in the region of the cross member connected to this end.

The mounting element that can be connected to the spare tire mounting makes it possible to structurally connect the central limb to supporting structural components of the motor vehicle body separately by means of the spare tire mounting such that any tensile forces introduced into the central limb via the seat belt buckle can be diverted into the motor vehicle body in an advantageous fashion via the connection to the spare tire mounting. Since the central limb not only can be connected to the spare tire mounting in a substantially detachable fashion by means of the hinge, but also by means of the mounting element, it is possible to realize a connection of the supporting structure to the motor vehicle body that lies about centrally between the lateral edges of the supporting structure of the seat mounting referred to the lateral vehicle direction (y).

In addition to an arrangement on the central limb, the mounting element may also be provided on the cross member of the supporting structure, generally on the underside thereof, such that the cross member, as well as the central limb directly connected thereto, can be separately connected to the motor vehicle body and therefore structurally stabilized, generally about centrally between their end sections referred to the lateral vehicle direction (y).

Since the mounting element of the supporting structure that cooperates with the spare tire mounting is furthermore arranged in the immediate vicinity of the seat belt buckle, a load path for the seat belt connection extending through the central limb can be realized in a comparatively short fashion.

According to another exemplary embodiment, the supporting structure may also feature two other lateral limbs that are supported on the motor vehicle body in a pivoted fashion by means of hinges with one end and can be locked on the motor vehicle body by means of at least one locking arrangement with an opposite end section. Since the supporting structure not only features the lateral limb, but also two other lateral limbs that extend along the lateral edges of the supporting structure, the overall supporting structure may provide an approximately closed frame for accommodating at least one vehicle seat.

All vehicle seats mounted on the supporting structure therefore can be transferred into a loading position with one or only a few manipulations by pivoting the supporting structure between its normal position and an upwardly folded loading position. In this exemplary embodiment, the backrests of the vehicle seats are previously folded forward onto a seat cushion in order to allow the vehicle seats to be pivoted into a loading position without colliding with seats arranged in front thereof referred to the driving direction, e.g., the seats of a second row of seats.

The lateral limbs generally extend parallel to the central limb and are advantageously connected to the at least one cross member with their rear end section referred to the driving direction. The mounting arrangement of the supporting structure is respectively arranged on a free end of the lateral limbs that faces away from the respective hinges or in the extension of the cross members extending between the limbs. In this case, the locking arrangement may typically feature one or more bolts that can be detachably mounted, for example, in a lock on the motor vehicle body. Due to such a locking arrangement or interlocking of the supporting structure, this supporting structure can be secured against unintentional pivoting motions and locked in the vehicle.

According to another exemplary embodiment, the locking arrangement of the supporting structure and the at least one mounting element that is generally arranged on the underside of the supporting structure can be transferred into a release position while they are coupled to one another. The mounting element that is arranged, for example, centrally between the lateral locking arrangements may be coupled to a central actuating element similar to the locking arrangements themselves, for example, by means of a flexible actuating element such as a cable pull or an electromechanical adjusting mechanism such that the end user merely has to actuate an actuating element in order to disengage the mutually interlocked mounting element and spare tire mounting, as well as a locking arrangement of the lateral limbs, in order to pivot the supporting structure of the seat mounting from its normal position into the loading position.

According to another one of various aspects of the present disclosure, a motor vehicle body is proposed that features at least one seat mounting of the above-described type with a supporting structure that is supported on the motor vehicle body in a pivoted fashion.

In one examplary embodiment, the motor vehicle body furthermore features a spare tire mounting that can be detachably connected to the supporting structure of the seat mounting by means of a mounting element. Referred to the vertical vehicle direction (z), the spare tire mounting extends underneath the supporting structure of the seat mounting, generally in a region that is spaced apart from a hinge provided for connecting the supporting structure of the seat mounting to the motor vehicle body in a pivoted fashion.

According to another exemplary embodiment, the spare tire mounting is realized in the form of a pin that extends from a bottom of a spare tire recess. The pin that generally extends in the vertical vehicle direction (z) may furthermore be provided for mounting a spare tire in the region of the spare tire recess. For example, the spare tire may be arranged in the spare tire recess such that its rim is approximately centered relative to the pin and detachably mounted on the pin of the spare tire recess with the aid of a screw that can be screwed on the pin and functionally engages with the rim. In this case, in one example, the pin is rigidly connected to the bottom of the spare tire recess, e.g., welded, screwed or riveted thereto.

The spare tire recess is generally realized in the form of a one-piece formed sheet metal part, the lateral edges of which are mounted on opposing longitudinal beams that extend in the longitudinal vehicle direction, as well as on at least one cross beam that connects the longitudinal beams to one another in the lateral vehicle direction (y). The mounting of the respective spare tire recess or formed sheet metal part to adjacent supporting structural components of the motor vehicle body is in one example, realized by means of welding, bonding and/or spot clinching.

According to another exemplary embodiment, the mounting element that is generally provided on the underside of the central limb of the supporting structure of the seat mounting features a socket for accommodating a free end section of the pin provided on the spare tire recess.

In another exemplary embodiment, the pin may detachably engage with a corresponding mounting element of the supporting structure of the seat mounting. On its free end, for example, the pin may feature a tapered insertion or contact bevel for the socket, as well as at least one undercut or one snap-in projection arranged adjacent thereto, while the socket may feature corresponding positive connecting means, in one example, a snap-in means, that can produce a positive connection effective in the longitudinal direction of the pin or in the vertical vehicle direction (z) in cooperation with the projections or undercuts of the pin.

According to another exemplary embodiment, it is furthermore proposed that the seat mounting, for example, the supporting structure, is designed for accommodating at least one seat of a third row of seats of a motor vehicle in a pivoted fashion. The supporting structure generally serves for accommodating all seats of a third row of seats of a motor vehicle, e.g., in the form of a minivan or multi-purpose vehicle.

According to another one of various aspects of the present disclosure, a motor vehicle is proposed that respectively features a motor vehicle body of the above-described type or at least one seat mounting of the above-described type.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a perspective representation of a motor vehicle body-in-white with a supporting structure of a seat mounting for a third row of seats pivotably supported thereon;

FIG. 2 shows another perspective representation of the motor vehicle body, wherein the supporting structure of the seat mounting is provided with seat belt buckles and trim elements;

FIG. 3 shows an enlarged side view of the illustration according to FIG. 2; and

FIG. 4 shows a partially sectioned side view according to FIG. 3 of a seat mounting in different pivoting positions.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

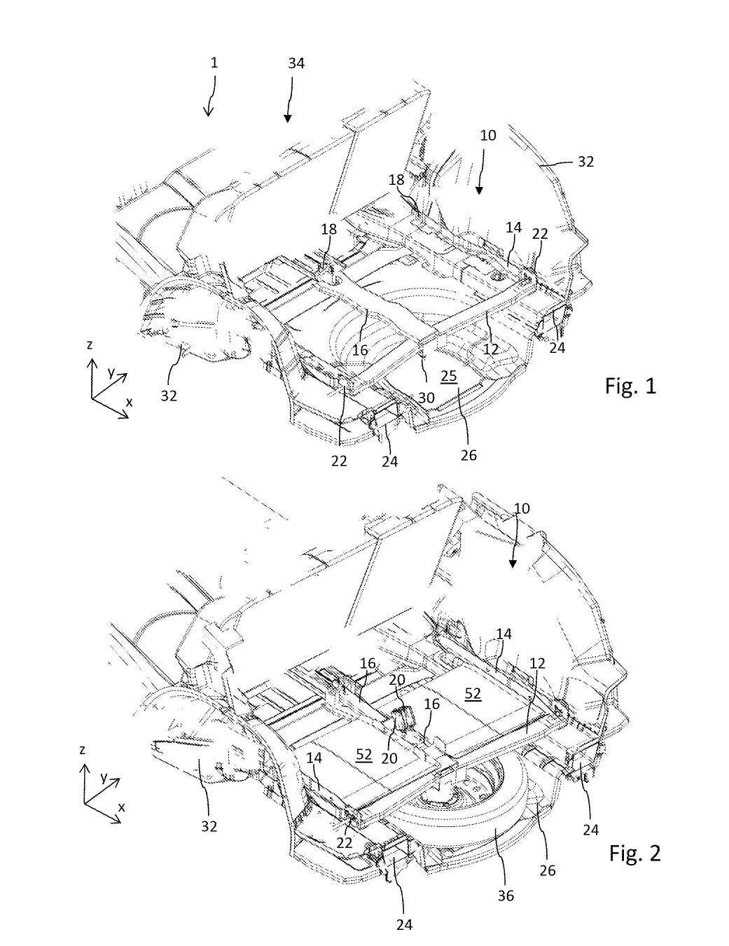

A motor vehicle body-in-white 1 of a motor vehicle featuring three rows of seats is sectionally illustrated in FIG. 1. In its rear region, the motor vehicle body 1 features two longitudinal beams 24 that substantially extend in the longitudinal vehicle direction (x) and on the outer sides of which two wheel housings 32 for the rear wheels of the motor vehicle are provided. A formed sheet metal part in the form of a spare tire recess 26 extends between the longitudinal beams 24. A second row of seats 34 that comprises a total of three vehicle seats is arranged in front of the spare tire recess 26 referred to the driving direction (x) of the motor vehicle.

Two front seats that are not explicitly illustrated, namely a driver seat and a front passenger seat, are arranged in front of this second row of seats. A seat mounting 10 for connecting a third row of seats 39 that features at least two vehicle seats 40 of the type illustrated in the form of a side view in a collapsed position in FIG. 4 is provided in the region behind the second row of seats 34. The seat mounting 10 features a supporting structure 11 with a total of three limbs, namely two lateral limbs 14 and a central limb 16, that substantially extend in the longitudinal vehicle direction (x) in the normal position illustrated in FIG. 1 and FIG. 2.

The lateral limbs 14, as well as the central limb 16, substantially extend parallel to one another, wherein the lateral limbs 14 are approximately arranged above the longitudinal beams 24 and the central limb 16 is approximately arranged centrally between the lateral limbs 14. The end section of all limbs 14, 16 that faces the second row of seats 34 is supported on supporting structural components of the motor vehicle body 1 in a pivoted fashion by means of individual hinges 18.

Opposite to the driving direction, i.e., facing away from the second row of seats 34, the lateral limbs 14, as well as the central limb 16, are interconnected by means of a cross member 12 that substantially extends in the lateral vehicle direction (y). The lateral limbs 14, the central limb 16 and the cross member 12 form a supporting structure 11 for accommodating at least two vehicle seats 40 of a third row of seats 39 to be arranged adjacent to one another in the lateral vehicle direction (y).

In one exemplary embodiment, it would furthermore be conceivable to structurally connect the front ends of all limbs 14, 16 facing the hinges 18 by means of another, e.g., front cross member that is not explicitly illustrated in this figure such that an altogether closed frame-like supporting structure can be formed by the front and the rear cross members, as well as the limbs 14, 16 extending in between. In this case, a hinge connection to the motor vehicle body could be realized by means of the front cross member such that any hinges can also be arranged independently and spaced apart from the limbs 14, 16 referred to lateral vehicle direction (y).

FIG. 2 furthermore shows that the central limb 16 serves for connecting two seat belt buckles 20 that are provided for being connected to corresponding seat belt clips of a two-point or three-point seat belt of the rear vehicle seats 40. In this case, the seat belt buckles 20 are spaced apart from the hinge 18 that is arranged in front referred to the vehicle driving direction. In addition, a mounting element 30 is provided on an underside of the central limb 16 and can cooperate with a spare tire mounting 28 arranged underneath the supporting structure 11.

The spare tire mounting 28 features a pin 29 that upwardly protrudes approximately in the vertical vehicle direction (z) and can detachably engage with the mounting element 30 of the supporting structure. In this respect, the mounting element 30 of the supporting structure may feature an approximately cylindrical bushing that can cooperate with an undercut of the pin 29.

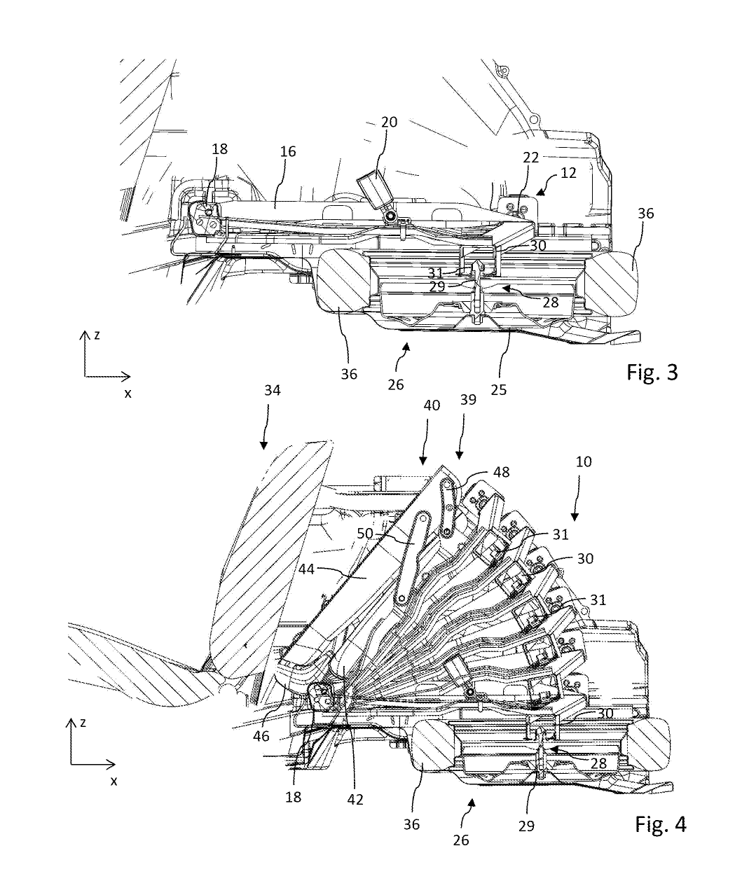

According to the cross section illustrated in FIG. 3, a structural connection or a central load path from the seat belt buckle 20 to the spare tire mounting 28 can therefore be realized by means of the central limb 16. Consequently, any tensile forces occurring on the seat belt buckle 20 can be diverted into the spare tire mounting 28 and therefore into the spare tire recess 26 arranged underneath the seat mounting 10 in a particularly effective fashion. The pin 29 is rigidly mounted on the bottom 25 of the spare tire recess 26 in this case.

In this way, a load-transmitting path between the seat belt buckle 20 and a comparatively stable component of the motor vehicle body such as, e.g., a spare tire mounting 28 can be realized comparatively short, as well as with little material input and therefore low weight. In addition, the direct mutual mounting of the supporting structure 11 and a spare tire mounting 28 makes it possible to achieve a system integration such that separate or structurally reinforcing components, e.g., for realizing a sufficient stability for the seat belt buckle connection can be advantageously eliminated.

According to FIG. 4, the entire supporting structure 11 with seats 40 arranged thereon can be transferred from an substantially horizontal normal position into an approximately upright loading position, in which a cargo floor that covers the spare tire recess 26 and is not explicitly illustrated in this figure can be at least sectionally lifted in order to gain access to the spare tire 36 mounted thereunder in the region of the spare tire recess 26.

According to FIG. 4, the seats 40 of the third row of seats 39 are realized such that they can be folded forward. Consequently, the backrests 44 of the seats can be folded forward onto a seat cushion 42 together with headrests 46 mounted thereon. In this case, the backrest 44 and the seat cushion 42 are interconnected in a pivoted fashion by means of two joints 48, 54 or links. In the forwardly folded configuration according to FIG. 4, the supporting structure 11 and therefore the entire seat mounting 10 with the seats 40 mounted on the supporting structure 11 can be pivoted forward into the loading position in order to thusly expose the region of a spare tire recess 26 that lies underneath the seat mounting and can be accessed from the interior of the motor vehicle.

FIG. 1 and FIG. 2 furthermore show a locking arrangement 22 of the motor vehicle body for the supporting structure 11. In their normal position, the rear end sections of the lateral limbs 14 that face away from the second row of seats 34 can be detachably locked on a locking arrangement 22 of the motor vehicle body provided on the longitudinal beams 24 together with the cross member 12. The locking arrangement 22 and the mounting element 30, for example, their locking or snap-in mechanisms, may be engaged, e.g., in an electromechanical or purely mechanical fashion, e.g., by means of a cable pull.

The lateral locking arrangements 22, as well as the mounting element 30 arranged about centrally on the supporting structure, therefore can be jointly transferred into a release position by means of a single actuating element that is actuated by the end user and not explicitly illustrated in this figure such that the seat mounting 10 locked on the motor vehicle body 1 can be disengaged with one or only a few manipulations and the seat mounting 10 with the supporting structure 11 and the vehicle seats 40 arranged thereon can be transferred into the loading position illustrated in FIG. 4.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A seat mounting for mounting at least one motor vehicle seat on a motor vehicle body, comprising:
a supporting structure for accommodating the at least one seat which is mounted on the motor vehicle body; and
at least one hinge that pivotally couples the supporting structure to the motor vehicle body and enables the supporting structure to be transferred between a normal position and a lifted loading position.

2. The seat mounting according to claim 1, wherein the supporting structure features a mounting element that is spaced apart from the hinge and is connectable to a spare tire mounting arranged underneath the supporting structure.

3. The seat mounting according to claim 2, wherein the supporting structure features at least one cross member and at least one limb that connects the cross member to the at least one hinge.

4. The seat mounting according to claim 3, wherein the supporting structure is designed for accommodating at least two adjacently arranged seats and features a central limb that extends between the seats.

5. The seat mounting according to claim 4, wherein at least one seat belt buckle is arranged on the central limb.

6. The seat mounting according to claim 5, wherein the mounting element is arranged on the central limb or on the cross member and is accessible from an underside that faces the spare tire mounting.

7. The seat mounting according to claim 1, wherein the supporting structure features two lateral limbs that are supported on the motor vehicle body in a pivoted fashion by a plurality of hinges at one end and the two lateral limbs are locked on the motor vehicle body by means of a locking arrangement at an opposite end section.

8. The seat mounting according to claim 7, wherein the locking arrangement and the mounting element can be transferred into a release position while they are coupled to one another.

9. A motor vehicle body, comprising:
at least one seat mounting that couples at least one seat to the motor vehicle body, the at least one seat mounting including:
a supporting structure for accommodating the at least one seat which is mounted on the motor vehicle body;
at least one hinge that pivotally couples the supporting structure to the motor vehicle body and enables the supporting structure to be transferred between a normal position and a lifted loading position; and
a spare tire recess arranged underneath the supporting structure of the at least one seat mounting, and the at least one seat mounting enables access to the spare tire recess in the loading position.

10. The motor vehicle body according to claim 9, further comprises a spare tire mounting that is detachably connectable to a mounting element of the supporting structure of the at least one seat mounting.

11. The motor vehicle body according to claim 10, wherein the spare tire mounting features a pin that extends from a bottom of the spare tire recess and is designed for detachably locking a spare tire.

12. The motor vehicle body according to claim 11, wherein the mounting element features a socket for accommodating a free end section of the pin.

13. The motor vehicle body according to claim 11, wherein the pin is designed such that it can detachably engage with the mounting element.

14. The motor vehicle body according to claim 9, wherein the at least one seat mounting is designed for accommodating at least one seat of a third row of seats of a motor vehicle in a pivoted fashion.

15. A motor vehicle, comprising:
at least one seat;
a motor vehicle body;
at least one seat mounting that couples the at least one seat to the motor vehicle body, the at least one seat mounting including:
a supporting structure for accommodating the at least one seat which is mounted on the motor vehicle body;
at least one hinge that pivotally couples the supporting structure to the motor vehicle body and enables the supporting structure to be transferred between a normal position and a lifted loading position;
a spare tire recess arranged underneath the supporting structure of the at least one seat mounting, and the at least one seat mounting enables access to the spare tire recess in the loading position; and
a spare tire mounting that is detachably connectable to a mounting element of the supporting structure of the at least one seat mounting.

16. The motor vehicle according to claim 15, wherein the spare tire mounting features a pin that extends from a bottom of the spare tire recess and is designed for detachably locking a spare tire.

17. The motor vehicle according to claim 16, wherein the mounting element features a socket for accommodating a free end section of the pin.

18. The motor vehicle according to claim 17, wherein the pin is designed such that it can detachably engage with the mounting element.

19. The motor vehicle according to claim 15, wherein the at least one seat mounting is designed for accommodating at least one seat of a third row of seats of a motor vehicle in a pivoted fashion.
